(19) United States
(12) Patent Application Publication
(10) Pub. No.: US 2019/0353575 A1
(43) Pub. Date: Nov. 21, 2019

(54) METHOD AND SYSTEM FOR MEASURING A PARAMETER OF A CORE SAMPLE

(71) Applicant: UTI Limited Partnership, Calgary (CA)

(72) Inventors: Christopher R. Clarkson, Calgary (CA); Atena Vahedian, Calgary (CA); Amin Ghanizadeh, Calgary (CA); Chengyao Song, Calgary (CA)

(21) Appl. No.: 16/413,006

(22) Filed: May 15, 2019

Related U.S. Application Data
(60) Provisional application No. 62/671,727, filed on May 15, 2018.

(51) Int. Cl. G01N 15/08

(52) U.S. Cl. CPC G01N 15/0826; G01N 15/0806

(57) ABSTRACT

There is described a method for measuring a parameter of a core sample. The method comprises injecting a fluid into a permeable core sample, allowing the injected fluid to flow out of the core sample by reducing a pressure in an exterior of the core sample relative to an interior of the core sample, measuring a flow rate of the fluid flowing out of the core sample, measuring a pressure of the fluid flowing out of the core sample, and determining, using the measured flow rate and the measured pressure, a parameter of the core sample. The parameter comprises one or more of a permeability and a pore volume of the core sample. A corresponding system is also described.

### CROSS- REFERENCE TO RELATED APPLICATION(S)

This application claims the benefit of Provisional U.S. Patent Application No. 62/671,727 filed May 15, 2018, and entitled “METHOD AND SYSTEM FOR MEASURING A PARAMETER OF A CORE SAMPLE,” the entire content and disclosure of which, both express and implied, is incorporated herein by reference

### FIELD OF THE DISCLOSURE

The present disclosure relates to a method and system for measuring a parameter of a core sample, and in particular a permeability and a pore volume of a core sample.

### BACKGROUND TO THE DISCLOSURE

Unconventional reservoirs such as shales (mudrocks) and coals may exhibit an ultra-low matrix permeability (<0.001 md), challenging conventional laboratory-based methods for permeability measurement. Small-diameter core plugs or crushed-rock samples, combined with unsteady-state methods, are currently favored to reduce measurement times for ‘tight’ rocks. For core plug analysis, unsteady-state pressure pulse-decay (PDP) or steady-state (SS) methods are commonly employed in commercial laboratories, with the core plug sample subjected to confining stress. Analysis times, particularly for SS methods, may be excessive for ultra-low permeabilities in the nanodarcy range. Another limitation of both PDP and SS experiments applied to core plugs is that they do not represent the boundary conditions typically used to produce hydrocarbons from unconventional reservoirs in the sub-surface through wells.

Rate-transient analysis (RTA) is a technique used to quantitatively analyze production data from wells drilled into unconventional reservoirs to extract reservoir (e.g. permeability, hydrocarbons-in-place) and hydraulic fracture (conductivity, fracture length) properties. Multi-fractured horizontal wells (MFHWs) producing from low-permeability reservoirs commonly exhibit the flow-regime sequence of transient linear flow, where hydrocarbons flow through the reservoir orthogonal to hydraulic fractures or the horizontal well, followed by boundary-dominated flow caused by pressure interference between adjacent hydraulic fractures or wells. Transient linear flow may be analyzed using RTA methods to extract fracture or well-length (if permeability is known); the end of linear flow can be used to estimate permeability of the reservoir, and boundary-dominated flow to estimate hydrocarbons-in-place.

### SUMMARY OF THE DISCLOSURE

The present disclosure seeks to provide an improved method and system for measuring a parameter of a core sample. While various embodiments of the disclosure are described below, the disclosure is not limited to these embodiments, and variations of these embodiments may well fall within the scope of the disclosure which is to be limited only by the appended claims.

In this study, a new experimental procedure for determining matrix permeability is introduced to better reproduce conditions under which wells produce in the field. The method produces flow-regimes consistent with those observed from field data, which can in turn be analyzed using rate-transient analysis (RTA) methods developed for the analysis of well production data. Two different estimates of permeability are obtained using two different rate-transient procedures, as well as an estimate of pore volume, using methane as the analysis gas. Other non-hydrocarbon/hydrocarbon gases could also be used, such as, argon, nitrogen, carbon dioxide, helium, ethane, and propane. The permeability values from the two methods are consistent with each other and reproducible (as demonstrated from multiple tests); the pore volume estimate is also consistent with independent measures. Finally, the permeability results using the new method are comparable to those obtained using the pulse-decay method under similar experimental conditions (confining and pore pressure) and using methane as analysis gas, but importantly were achieved in much shorter timeframe. This new core analysis method and associated experimental procedure will be of practical interest to reservoir characterizers interested in laboratory-based methods that better represent conditions in the field.

In this work, a new experimental procedure, applied to core plugs under stress conditions, is developed to mimic well operating conditions used in the field (i.e. producing from a subsurface unconventional reservoir). After injection of the analysis gas into one end of the core plug, and pressure stabilization, the gas is flowed out one end of the core plug at constant pressure (with the aid of a back-pressure regulator), and flow rates are measured with a flow meter. This procedure is applied to a core plug extracted from a low-permeability siltstone of the Montney Formation (western Canada), using methane as the analysis gas. Repeated testing consistently demonstrated a transient linear flow period, as the gas pressure transient propagated along the core plug, followed by boundary dominated flow after the pressure transient reached the end of the core plug; this sequence is identical to what is commonly observed in the field. Permeability was estimated using both the slope of a square-root of time plot (a common RTA method used to analyze transient linear flow), and the end of linear flow using the linear distance of investigation (DOI) equation. Permeability from both techniques is in good agreement (±5% for both experiments performed), providing an important redundancy to the analysis procedure. Pore volume (and hence porosity, with bulk volume known) may be estimated from the end of linear flow—the calculated value is in excellent agreement (±2% for both experiments performed) with that obtained from pore volume/porosity estimates using helium pycnometer (combined with calipered dimensions). Finally, test times for the ˜0.0007 and core plug sample, after the initiation of the production phase, are on the order of only a few minutes to obtain the two independent estimates of permeability and pore volume, which is significantly faster than that achievable from a PDP test (about 30 minutes faster under the same experimental conditions).

The new innovative experimental procedure is successful in reproducing the physics of flow in unconventional reservoirs, with the results being analyzable with the same techniques applied to field data.

In a first aspect of the disclosure, there is provided a method for measuring a parameter of a core sample. The method comprises: injecting a fluid into a permeable core sample; allowing the injected fluid to flow out of the core sample by reducing a pressure in an exterior of the core sample relative to an interior of the core sample; measuring a flow rate of the fluid flowing out of the core sample; measuring a pressure of the fluid flowing out of the core sample; and determining, using the measured flow rate and the measured pressure, a parameter of the core sample, wherein the parameter comprises one or more of a permeability and a pore volume of the core sample.

Prior to injecting the fluid, the core sample may be evacuated of gas.

After injecting the fluid and before allowing the fluid to flow out of the core sample, a pressure within the core sample may be allowed to stabilize.

The fluid may be injected at multiple entry points in the core sample. The fluid may be injected at opposite ends of the core sample.

The core sample may be contained in a core holder configured to exert a pressure on the core sample so as to contain under pressure the fluid within the core sample. Thus, the core holder may simulate the stress regimes that the core sample would undergo “in-situ”.

A back-pressure regulator fluidly connected to the core sample may be used to reduce the pressure in the exterior of the core sample.

Determining the parameter may comprise using rate transient analysis with the measured flow rate and the measured pressure of the fluid flowing out of the core sample.

The fluid may comprise one or more non-hydrocarbon/hydrocarbon gases such as methane, argon, nitrogen, carbon dioxide, helium, ethane, and propane.

After injecting the fluid, a pressure of the fluid in the core sample may be up to about 10,000 psi, or up to about 20,000 psi.

Determining the parameter of the core sample may further comprise using: an ambient temperature, a compressibility of the fluid, a viscosity of the fluid, an estimated porosity of the core sample, a cross-sectional area of the core sample, a drawdown correction factor, a slope of rate-normalized pseudopressure of the fluid flowing out of the core sample as a function of time.

Determining the parameter of the core sample may further comprise using: a compressibility of the fluid, a viscosity of the fluid, an estimated porosity of the core sample, a length of the core sample, and a time at which a rate-normalized pseudopressure of the fluid flowing out of the core sample is determined to no longer be linear.

In a further aspect of the disclosure, there is provided a system for measuring a parameter of a core sample. The system comprises: a supply of fluid; a permeable core sample fluidly connected to the supply of fluid; a core holder configured to apply pressure to the core sample so as to contain under pressure a fluid within the core sample; a back-pressure regulator fluidly connected to the core sample and configured to reduce a pressure in an exterior of the core sample relative to an interior of the core sample; a flow sensor for measuring a flow rate of a fluid flowing out of the core sample; and a pressure sensor for measuring a pressure of a fluid flowing out of the core sample.

The system may further comprise a vacuum pump configured to evacuate the core sample of gas.

The core sample may be fluidly connected to the supply of fluid via multiple entry points of the core sample.

The core sample may be fluidly connected to the supply of fluid via opposite ends of the core sample.

The core holder may be configured to apply to the core sample a pressure of up to about 10,000 psi, or up to about 20,000 psi.

The system may further comprise one or more processors communicatively coupled to a computer-readable medium having stored thereon computer program code configured when executed by the one or more processors to cause the one or more processors to perform a method comprising determining, using a flow rate obtained from the flow sensor and a pressure obtained from the pressure sensor, the parameter of the core sample, wherein the parameter comprises one or more of a permeability and a pore volume of the core sample.

Determining the parameter of the core sample may comprise using rate transient analysis with a flow rate obtained from the flow sensor and a pressure obtained from the pressure sensor.

Determining the parameter of the core sample may further comprise using: an ambient temperature, a compressibility of the fluid, a viscosity of the fluid, an estimated porosity of the core sample, a cross-sectional area of the core sample, a drawdown correction factor, a slope of rate-normalized pseudopressure of fluid flowing out of the core sample as a function of time.

Determining the parameter of the core sample may further comprises using: a compressibility of the fluid, a viscosity of the fluid, an estimated porosity of the core sample, a length of the core sample, and a time at which a rate-normalized pseudopressure of fluid flowing out of the core sample is determined to no longer be linear.

### BRIEF DESCRIPTION OF THE DRAWINGS

Specific embodiments of the disclosure will now be described in detail in conjunction with the accompanying drawings of which:

FIG. 1 is a schematic diagram of unsteady-state measurement techniques used commonly for estimating permeability in tight reservoirs. The middle column of boxes depicts the sample type (core plug, slabbed core or crushed-rock) used and stress condition applied. The right column indicates the pressure measurement technique (pressure- or pulse-decay) used.

FIG. 2 shows an experimental workflow for petrophysical, geochemical and geomechanical evaluation of low-permeability reservoirs samples.

FIG. 3 shows a possible sequence of flow-regimes expected for multi-fractured horizontal wells (MFHWs) producing from an ultra-low permeability reservoir.

FIG. 4 shows a possible sequence of flow-regimes for MFHWs exhibiting complex fracturing corresponding to the enhanced fracture region ‘EFR’ case.

FIGS. 5A and 5B show pseudopressure-normalized-rate (PNR) plots (log-log) used to identify flow-regimes for field case exhibiting ‘EFR’ behavior, and analysis of linear flow periods using square-root of time plot.

FIG. 6 is a log-log plot of gas rate versus time for a simulated core test (production test cycle). Transient linear flow is identified as a negative ½ slope (solid black line drawn through gas rate data). The deviation downward from the ½ slope line indicates the beginning of boundary-dominated flow.

FIG. 7 is a square-root time plot for a simulated core test (production test cycle). The slope of the square-root of time plot is used to derive one estimate for permeability. The end of linear flow (vertical green line) may be used to provide a second estimate of permeability, as well as pore volume (i.e. porosity).

FIG. 8 is a system for determining a permeability of a core sample, in accordance with an embodiment of the disclosure.

FIG. 9 is a plot of raw pressure and rate data associated with the production cycle of the core tests.

FIGS. 10A and 10B show log-log plots of gas rate versus time and gas material balance time for an actual core test (production test cycle).

FIG. 11 shows a square-root time plot for an actual core test (production test cycle).

FIG. 12 shows experimental results comparing pulse-decay permeability and RTAPK permeability at various mean pore pressures and under various effective stress conditions.

FIGS. 13 and 14 show estimated liquid permeability values using a square-root of time and distance of investigation (DOI) method based on forecasted oil flow rates for hypothetical core plug samples.

### DETAILED DESCRIPTION OF EMBODIMENTS

While induced hydraulic fractures, natural fractures and other large-scale reservoir heterogeneities are important controls on the productivity of wells completed in ultra-low permeability (‘tight’) reservoirs, such as shales, between-fracture matrix permeability is commonly considered to be a key reservoir property affecting long-term production. Matrix permeability is therefore a required input to reservoir simulators used to forecast performance of wells completed in tight reservoirs. Field-based techniques for permeability estimation in tight reservoirs, such as diagnostic fracture injection tests (DFIT), flow/buildup tests (FBUT), and rate-transient analysis (RTA) often cannot yield an estimate of matrix permeability because 1) flow-regimes required for independent permeability assessment may not be observed in the time-frame of the test (e.g. DFIT and FBUT), and, even if they are, such as for longer-term RTA evaluations, 2) the derived permeability may be impacted by the aforementioned large-scale heterogeneities. As a result of 2), the field-estimated permeability value could be several orders of magnitude larger than the true matrix permeability. Therefore, laboratory-based methods are still commonly relied upon for matrix permeability assessment.

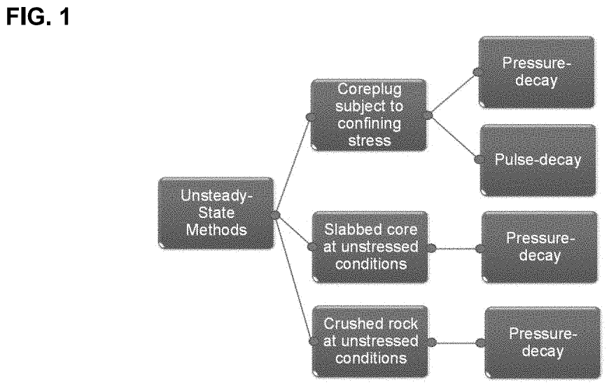

Laboratory-based permeability measurements may be broadly classified into steady-state (SS) and unsteady-state (USS) methods. Because of the long measurement times for SS methods as applied to whole core and core plugs taken from ultra-low permeability reservoirs, and the need to measure flow rates, which becomes more inaccurate with a decrease in permeability, USS techniques have gained in popularity over the past two decades. USS methods involve the measurement of pressure transients (and temperature), which are experimentally easier to determine than rate. USS methods may be applied to core plugs, crushed-rock or slabbed cores (see FIG. 1); while core plugs are usually subjected to confining stress for USS tests, slabbed cores or crushed-rock measurements are usually performed at unstressed conditions.

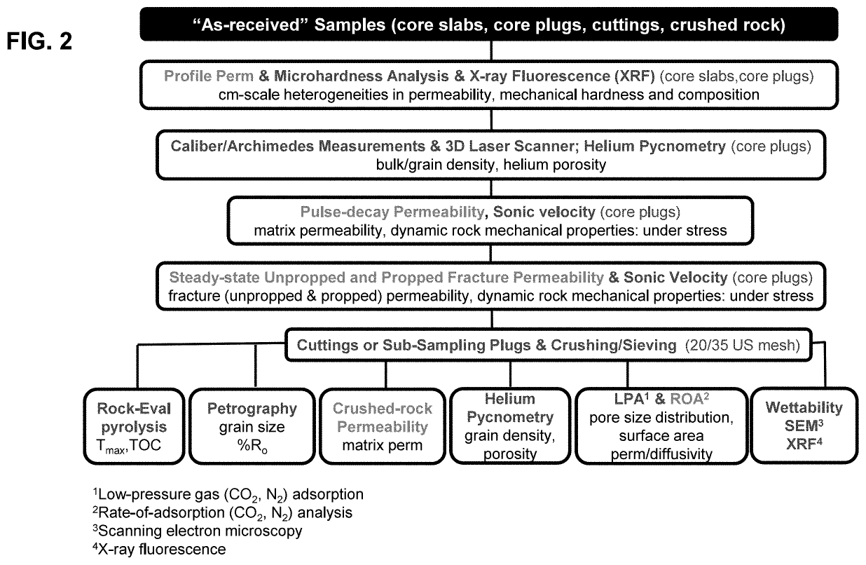

A combination of USS and SS permeability estimation methods have been incorporated into a reservoir sample (core slab, core plugs, crushed rock and drill cuttings) analysis workflow which provides a systematic approach for obtaining petrophysical, geomechanical, geochemical and wettability (fluid-rock interaction) properties for tight rock (see FIG. 2). Slabbed cores are analyzed using a pressure-decay profile (probe) permeability tool (PDPK-400™—CoreLab®) in order to quantify sub-cm-scale variations in permeability along the length of the slabbed core. This information is used in turn to select locations for core plug extraction; ideally several plugs are selected per rock type/flow unit identified using the PDPK-400™ device for additional study as discussed further below. A limitation of the PDPK-400™ device is that permeability is measured on unstressed core slabs, and the lower limit for permeability estimation is 0.001 md. Both of these limitations are overcome through analysis of core plug permeability under stress—for each rock-type, a correlation between PDPK measurements performed on the ends of unstressed core plug and whole core plug measurements performed under stress using the pulse- or pressure-decay technique may be used to “correct” the PDPK measurements to in-situ stress conditions. This approach is desirable because of the relatively high density of PDPK measurements that can be performed. Nonetheless, the lower-limit permeability resolution (˜0.001 md), which can be as low as 0.0001 md after correction to in-situ conditions, limits the method to tight rocks and may not be applicable to many shales.

Once rock types have been identified based on cm-scale variations in rock composition, mechanical properties and permeability (using PDPK), a number of core plugs are extracted for permeability measurement under confining stress using the pulse-decay permeability (PDP) method. PDP is amongst the most commonly applied USS methods for analysis of core plugs (either 1 inch or 1.5 inch diameter) subject to confining stress; it is therefore useful for evaluating the impact of stress on permeability. The PDP-250™ (CoreLab®) has a dynamic range of 10 nanodarcy to 100 microdarcy and therefore spans a range of permeabilities that fall within the range of unconventional reservoirs. This technique may be used to evaluate not only the stress-dependence of matrix permeability, because the core plugs can be subject to variable confining stress, but also the dependence of permeability on flow direction. Therefore, with an understanding of in-situ flow direction in the reservoir and its relationship to rock fabric, PDP experiments may be designed to systematically investigate directional-dependence of permeability affecting flow in the reservoir—use of cubic samples is advantageous for this purpose; however the PDP method typically uses cylindrical samples. A primary limitation of the PDP technique is that the extracted core plugs may contain stress-release fractures that artificially inflate the matrix permeability values at low confining stress; further, measurement times for ultra-low permeability rocks (e.g. <100 nd) may be excessive (hours).

While pressure-decay measurements can be performed on either crushed-rock at ambient (unconfined) stress conditions or on core plugs subject to confining stress, the former has gained favor for ultra-low permeability rocks because of 1) relatively quick measurement times and 2) the perception that crushing the rock can eliminate micro-fractures that influence core plug measurements. In the workflow illustrated in FIG. 2, core plugs are crushed to a standard sieve size (20/35 U.S. mesh) and pressure-decay measurements performed using an SMP-200™ (CoreLab) device so that crushed-rock and core plug measurements may be compared using the exact same sample. The SMP-200™ has a dynamic range of 0.1 nanodarcy to 1 microdarcy, and has the advantage over PDP that measurements are fast in the nanodarcy range. However, crushed-rock analysis cannot be performed on samples subject to stress. Further, because flow is multi-directional to the rock particles in a crushed rock experiment, the effect of fabric on permeability anisotropy cannot be assessed. Pressure-decay data collected during a low-pressure adsorption experiment may be used to estimate permeability/diffusivity from small masses of crushed-rock or drill cuttings. Small masses (<5 g) of drill cuttings, which typically cannot be analyzed using commercial crushed rock devices, may be analyzed quantitatively in order to assess variability in permeability along horizontal wells for which the only reservoir samples obtained are drill cuttings.

Recent studies in which the PDP (using PDP-250™) and PDPK measurements (using PDPK-400™) were performed on the same core plugs, as well as crushed-rock permeability measured on the same core plugs crushed to 20/35 (U.S. mesh) size, demonstrated marked differences in the permeability obtained from each technique. For example, for the Montney core plug samples analyzed by Ghanizadeh, A., Clarkson, C. R., Aquino, S., Ardakani, O. H. and Sanei, H., 2015, Petrophysical and geomechanical characteristics of Canadian tight oil and liquid-rich gas reservoirs: I. Pore network and permeability characterization, Fuel 153, 664-681, the PDPK measurements performed on the core plug ends, and PDP measurements performed down the axis of the core, are substantially different with the PDPK values being typically several fold higher than the PDP values. After correction to in-situ stress, the PDPK and PDP values were aligned. However, the crushed-rock values were still several fold to >1 order of magnitude smaller than PDP/corrected PDPK values.

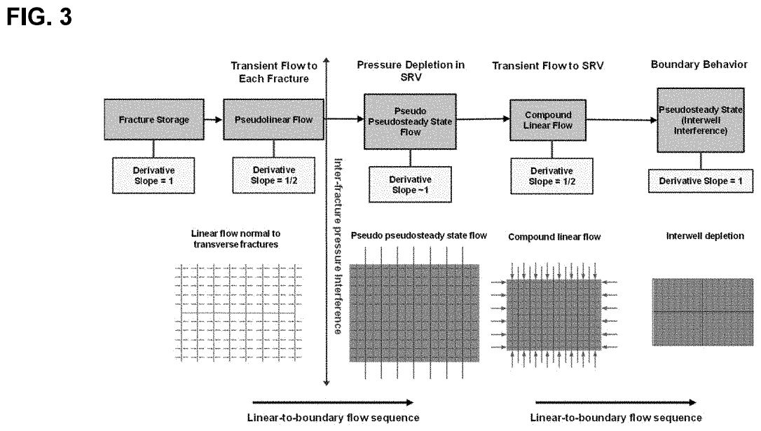

A primary limitation of all the laboratory-based unsteady-state techniques commonly used for matrix permeability measurement is that the boundary conditions of the experiments do not properly reflect those occurring in the field during well production. As a result, the flow-regime sequence observed in the laboratory may not be consistent with what is observed in the field, and an “apples-to-apples” comparison of field- and laboratory-derived permeability estimates is not achievable. FIG. 3 illustrates a possible flow-regime sequence for a multi-fractured horizontal well completed in an ultra-low permeability shale reservoir. A commonly observed flow-regime coupling is transient linear flow followed by boundary-dominated flow. In FIG. 3, there are two of these sequences depicted: 1) transient linear flow between transverse (primary) hydraulic fractures followed by pressure depletion within the ‘stimulated reservoir volume’ (SRV), which is an area around the primary hydraulic fracture in which reservoir permeability may be enhanced due to the hydraulic fracture treatment (e.g. reactivated natural fractures), and 2) compound linear flow to the SRV followed by depletion of the inter-well volume. For 1), pure depletion within the SRV may not be observed because flow from outside the SRV to within the SRV is occurring (referred to as “pseudosteady state flow” in FIG. 2). For 2), a long transition between transient linear flow between wells, and inter-well depletion may occur. With respect to permeability estimation, sequence 1) may be used to evaluate a system permeability, which is expected to be inflated above true matrix permeability because of reactivation of natural fractures caused by the hydraulic fracture treatment; sequence 2) may be used to estimate a true reservoir permeability, but this is also expected to be larger than matrix permeability because of the existence of large-scale heterogeneities.

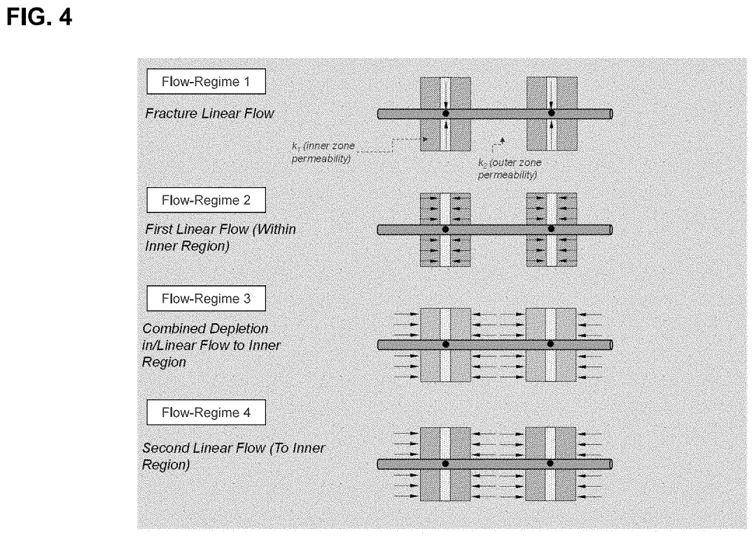

Another scenario in which multiple linear-to-boundary sequences may occur is when the SRV is limited in extent around the primary hydraulic fracture. This scenario is depicted in FIG. 4 (for two primary fractures only)—complex fracturing may lead to an enhanced fracture region (‘EFR’) around the primary (propped) hydraulic fracture, which can be modeled using an SRV of more limited extent around the primary fracture. For this scenario, although an early fracture linear flow is possible (flow-regime 1 of FIG. 4), it will not generally be observable with typical production data—the first transient linear flow regime expected to be observed is linear flow within the SRV (flow-regime 2) around the primary hydraulic fracture (referred to as ‘inner region’ in FIG. 4). This first linear flow period is followed by a pseudosteady-state flow period (flow-regime 3, combined inner region depletion and linear flow to the inner region), analogous to that depicted in FIG. 3. Finally, a second transient linear flow period in the reservoir occurs between inner regions around the fractures (flow-regime 4), followed perhaps by inter-fracture interference (not depicted). As described above, two reservoir permeability estimates could be obtained from this sequence, with the first linear-to-boundary flow sequence within the inner region providing an ‘SRV permeability’ (k₁ in FIG. 4), and the second providing an estimate of outer region (reservoir) permeability (k₂ in FIG. 4).

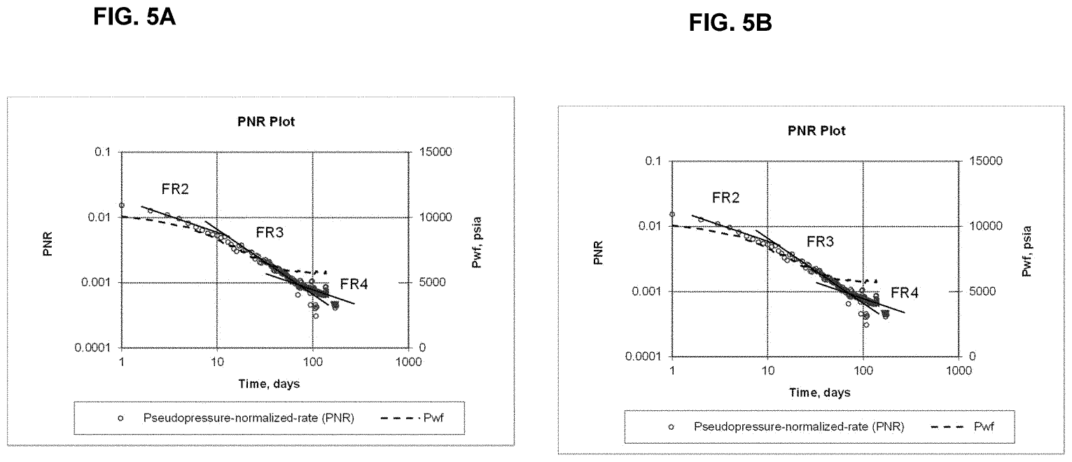

Clarkson, C. R., Williams-Kovacs, J. D., Qanbari, F., Behmanesh, H. and Heidari-Sureshjani, M., 2015, History-matching and forecasting tight/shale gas condensate wells using combined analytical, semi-analytical, and empirical methods, Journal of Natural Gas Science and Engineering 26, 1620-1647, provided an analysis of real field data (a multi-fractured horizontal well producing from a shale reservoir) corresponding to the scenario depicted in FIG. 4 (flow-regimes 2-4). Following the RTA workflow discussed in Clarkson, C. R., 2013, Production data analysis of unconventional gas wells: review of theory and best practices, International Journal of Coal Geology 109-110 (1), 101-146, and Clarkson, C. R., 2013, Production data analysis of unconventional gas wells: workflow, International Journal of Coal Geology 109-110 (1), 147-157, the flow-regimes are first identified using diagnostic plots—in FIG. 5A a pseudopressure-normalized-rate (PNR) plot (log-log) is used for this purpose. As will be discussed further below, the slope of straight lines fit to different portions of this plot (or versions of it) may be used to identify the flow-regimes. Having identified the flow-regimes, a square-root of time plot (FIG. 5B) may be used to analyze the transient linear flow periods—as illustrated on this plot, two linear flow periods are interpreted to correspond to early (flow-regime 2, FIG. 4) and late (flow-regime 4, FIG. 4) linear flow within and external to, respectively, the inner region or SRV. These two linear flow periods are separated by flow-regime 3 (pseudo steady-state flow-regime). Using the conceptual model of FIG. 4, where linear flow is orthogonal to the primary fracture, and parallel to the horizontal well, the slope of the straight line may be used to estimate A√k where A corresponds to the area of the fracture (or total area of fractures for multi-fractured horizontal well case), and permeability is the region through which gas flows during the transient linear flow period. For early linear flow, this is k₁, and for late linear flow, this is k₂. Knowing one of the parameters, the other two may be determined. Of relevance to the current discussion, if A is known, then permeability of the SRV and non-stimulated reservoir may be assessed. An estimate of the SRV size may be provided using a method to analyze flow-regime 3.

One objective of the present disclosure is to present an unsteady-state core plug analysis method (using for example methane as the analysis gas) that can be analyzed using the same methods as demonstrated in the field case provided. As a result, a more “apples-to-apples” comparison between field testing and laboratory testing may now be possible. The core test procedure may use boundary conditions very similar to a flowing well scenario. Further, the resulting flow-regime sequence may be linear-to-boundary flow, which is commonly observed in field tests (FIGS. 3-5). Two estimates of permeability may be obtained from the test, provided the end of linear flow is observed, adding an important redundancy to the analysis. Further, provided the end of linear flow is observed, porosity may also be obtained. As a “bonus”, preliminary testing has demonstrated that permeability estimates may be obtained much more quickly than for other unsteady-state techniques.

In the following, rate-transient analysis theory, as applied to the proposed core analysis technique, is first reviewed and demonstrated with a simulated case initially shown by Clarkson, C. R., and Qanbari, F., 2013, Use of pressure-and rate-transient techniques for analyzing core permeability tests for unconventional reservoirs: Part 2, Paper SPE 167167, presented at the SPE Unconventional Resources Conference-Canada held in Calgary, Alberta, 5-7 November. The new experimental setup designed to enable RTA of core data is then described. Finally, application of the new experimental method and associated analysis is demonstrated using a core plug extracted from a low-permeability reservoir within the Montney Formation of western Canada.

Clarkson, C. R., Nobakht, M., Kaviani, D. and Kantzas, A., 2012, Use of pressure-and rate-transient techniques for analyzing core permeability tests for unconventional reservoirs, Paper SPE 154815 presented at the SPE Americas Unconventional Resources Conference held in Pittsburgh, Pa., 5-7 June, and Use of pressure-and rate-transient techniques for analyzing core permeability tests for unconventional reservoirs: Part 2 (the contents of which are hereby incorporated by reference), demonstrated that rate- and pressure-transient analysis methods, and the RTA workflow provided by Production data analysis of unconventional gas wells: review of theory and best practices, and Production data analysis of unconventional gas wells: workflow (the contents of which is hereby incorporated by reference), may be used to extract permeability from low-permeability reservoirs samples by using simulated (theoretical) examples.

Generally, the flow-regimes encountered during production are first identified. A log-log plot of rate-normalized-pseudopressure (RNP), and its semilog derivative (RNP′) with respect to the natural log of material balance pseudotime (note the pseudovariables i.e. pseudopressure and pseudotime are used instead of pressure and time for gas reservoirs); for production data analysis, a log-log plot of pseudopressure-normalized-rate versus material balance pseudotime may also be used—these plot variables are defined below (for completeness, PNR′ is also given):

$$\begin{matrix}RNP = \frac{{p}_{pg} ( {p}_{i} ) - {p}_{pg} ( {p}_{wf} )}{{q}_{g} ( t )} & ( 1 ) \\ {RnP}^{′} = \frac{dRNP}{{dlnt}_{cag}} & ( 2 ) \\ PNR = \frac{{q}_{g} ( t )}{{p}_{pg} ( {p}_{i} ) - {p}_{pg} ( {p}_{wf} )} & ( 3 ) \\ {PNR}^{′} = \frac{dPNR}{{dlnt}_{cag}} & ( 4 ) \\ {p}_{pg} = 2 {\int }_{0}^{p} \frac{p}{{μ}_{g} ( p ) z ( p )} dp & ( 5 ) \\ {t}_{cag} = \frac{{μ}_{gi} {c}_{ti}}{{q}_{g} ( t )} {\int }_{0}^{t} \frac{{q}_{g} ( t )}{{μ}_{g} ( \overline{p} ) {c}_{t} ( \overline{p} )} dt & ( 6 )\end{matrix}$$

where p_{pg}=gas pseudopressure, q_{g}=gas rate, μ_{gi} and cₜᵢ are gas viscosity and total compressibility at initial pressure, and μ_{g}(p̅) and cₜ(p̅) are the same parameters at average pressure. Use of pressure-and rate-transient techniques for analyzing core permeability tests for unconventional reservoirs: Part 2 used the following approximation for gas material balance pseudotime:

$${t}_{cag} \approx {t}_{cg} = \frac{{Q}_{g} ( t )}{{q}_{g} ( t )} \qquad ( 7 )$$

where Q_{g} is the cumulative gas production.

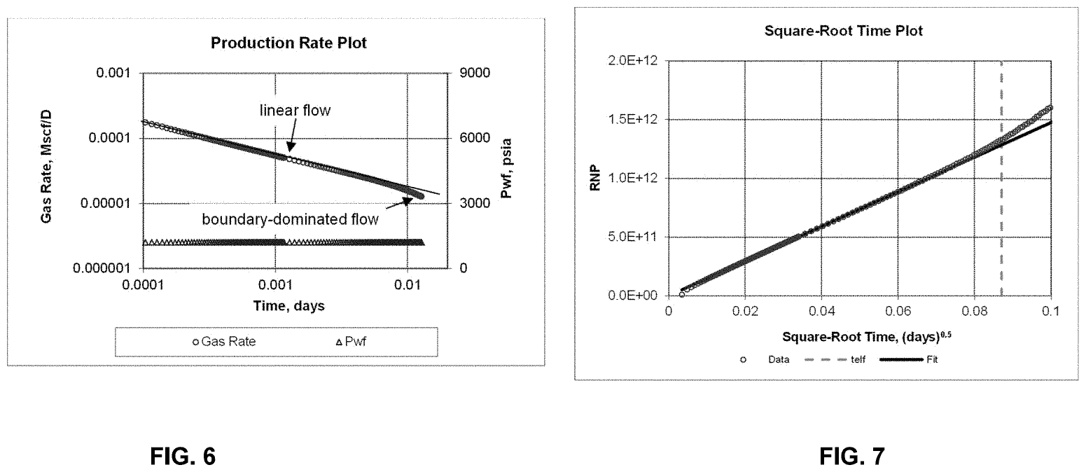

For the simulated case, because flowing pressure is constant, a log-log plot of rate versus time serves to help identify the flow-regimes in this case (FIG. 6). RNP derivative may be used for this purpose. A negative ½ slope line drawn through the data in FIG. 6 identifies the dominant flow regime as transient linear flow—the deviation downward from this line at late time suggests the beginning of boundary-dominated flow. Therefore, as with field cases described above, a transient linear to boundary-dominated flow sequence is observed.

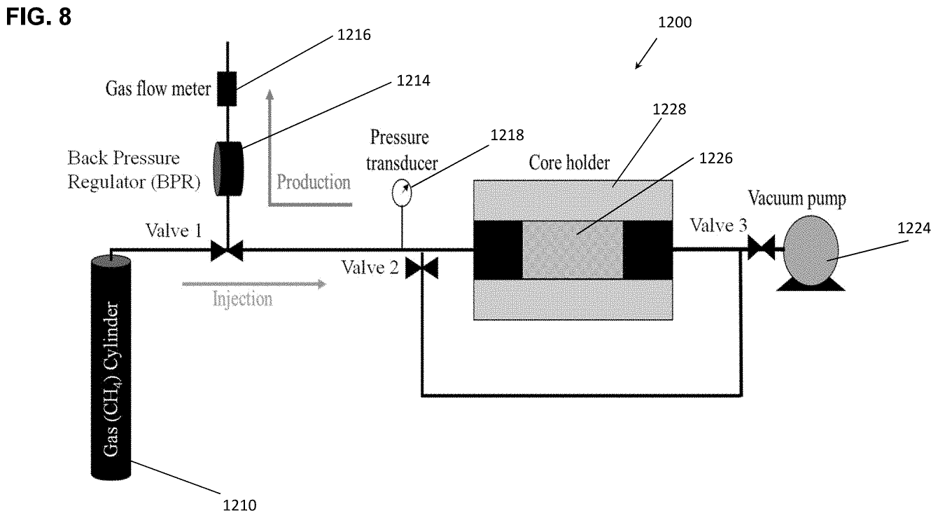

With the transient linear flow period identified, following the procedure of Use of pressure-and rate-transient techniques for analyzing core permeability tests for unconventional reservoirs: Part 2, the flow-regime can be used to estimate permeability using two methods. The first method uses the slope of the square-root of time plot:

$${k}_{a} = {( \frac{{f}_{cp}}{{A}_{c} {m}_{cp}} \frac{1262 T}{\sqrt{{φ}_{i} {μ}_{gi} {c}_{ti}}} )}^{2} \qquad ( 8 )$$

where kₐ is the apparent permeability to gas, μ_{gi} and cₜᵢ are the gas viscosity and total compressibility at initial gas pressure, ϕᵢ is porosity at initial pressure, T is temperature, A_{c} is the core cross-section area in this application (fracture surface area in RTA of well data), m_{cp} is the slope of the square-root of time plot, and f_{cp} is a drawdown correction that can be obtained analytically and is used to correct for pressure-dependent properties of gas, as well as adsorption and non-Darcy flow effects. Use of pseudotime (tₐ) instead of time (days) in the square-root of time plot circumvents the need for this correction. The subscript ‘cp’ indicates the use of the constant pressure solution for transient linear flow. Note that core cross-sectional area is required to estimate permeability in Eq. 8. Eq. 8 is only applicable for constant flowing pressure—for variable flowing pressures, superposition time functions will be required. The square-root time plot for the simulated core data is provided in FIG. 7, from which (using Eq. 8) a permeability estimate of 9.30×10⁻⁵ and is obtained (within 7% of model input of 1×10⁻⁴ md—Table 1).

Identification of the end of the transient linear flow period provides for a second method of permeability determination, as well as pore volume estimation. Using the transient linear distance of investigation (DOI) concept, and noting the end of linear flow (t_{elf} in FIG. 7), permeability may be estimated as follows:

$${k}_{a} = {( \frac{{L}_{c}}{0.159} )}^{2} \frac{{φ}_{i} {μ}_{gi} {c}_{ti}}{{t}_{elf}} \qquad ( 9 )$$

where L_{c} is the length of the core plug sample, and t_{elf} (days) is the end of linear flow. Eq. 9 may be modified for desorption effects, or non-Darcy flow effects. Use of Eq. 9 does not require an estimate of rate, which is useful in cases where rate measurement is experimentally challenging. Using Eq. 9, permeability of the simulated core is estimated to be 1.03×10⁻⁴ md (within 4% of model input of 1×10⁻⁴ md—Table 1). Pore volume may be estimated using t_{elf} combined with the slope of the square-root of time plot as follows:

$${V}_{p} = {f}_{cp} \frac{200.8 T \sqrt{{t}_{elf}}}{{m}_{cp} {μ}_{gi} {c}_{it}} \qquad ( 10 )$$

Eq. 10, in combination with an estimate of the bulk volume of the core plug (from calipering the sample, fluid immersion techniques, or 3D laser scanner) allows porosity to be estimated. For the simulated example, a pore volume of 5.169×10⁻⁵ ft³ (1.47×10⁻⁶ m³) is obtained, which is within approximately 5% of the simulation model input. A summary of the two permeability estimates, and the pore volume estimate, is provided in Table 2.

TABLE 2
Permeability (apparent permeability to gas) and pore volume estimates
obtained from rate-transient analysis of simulated core test.

| Parameter Estimated | | |
|---|---|---|
| Value | Parameter | Error |
| Pore volume (ft³) | 5.169 × 10⁻⁵ | −5.2 |
| Permeability (md)* | 1.034 × 10⁻⁴ | 3.4 |
| Permeability (md)** | 9.297 × 10⁻⁵ | −7.0 |

*Using distance of investigation (DOI) method
**Using slope of square-root time plot

Importantly, in this example, the end of transient linear flow, which allows the two independent estimates of permeability and pore volume to be obtained, was observed in ˜10 minutes. A few more minutes would be required to observe a clear boundary-dominated flow signature. The technique described therefore has the added advantage of speed—for example, pulse-decay estimates of permeability for similar permeability levels may require hours.

In summary, using rate-transient analysis techniques, and provided linear-to-boundary flow is observed, two independent estimates of permeability may be obtained; one method uses the slope of the square-root of time plot, and the other uses the linear flow distance of investigation equation combined with an estimate of the time at the end of linear flow. Pore volume and porosity may also be estimated from the slope of the square-root time plot, and using the time at the end of linear flow. Although not illustrated above, type-curve methods and analytical model production history-matching of the data may be used to confirm the permeability and porosity estimates. For the simulated example, permeability and pore volume estimates are well within 10% of the simulation model input. Although complexities such as gas desorption and non-Darcy flow effects (due to gas slippage, transitional flow or diffusion) were not included in the simulation case analyzed herein, these effects may be taken into account in rate-transient analysis methods. Further stress-dependent porosity and permeability effects may be included. A constant flowing pressure case was illustrated—if flowing pressure is not constant, and production rate is affected, the combination of superposition time (or pseudotime) and pressure- (or pseudopressure) normalized-rate may be used to account for this.

Application of the above-described methods to actual core analysis data will now be described.

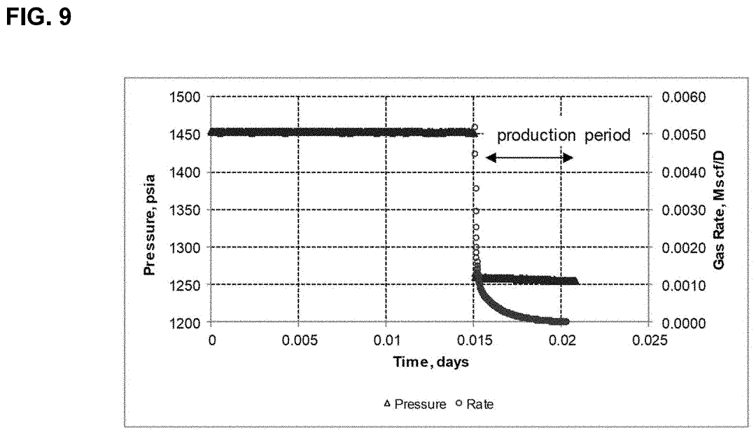

In accordance with an embodiment of the disclosure, an experimental apparatus was constructed to enable the core analysis approach described in the previous section. The experimental setup 1200 (FIG. 8) comprises of core holder 1228 holding core sample 1226, vacuum pump 1224, back-pressure regulator (BPR) 1214, gas flow meter 1216, gas cylinder 1210, pressure transducer 1218 and various valves 1, 2 and 3 to control flow into and out of the core holder 1228. The core holder 1228 is an acoustic velocity biaxial core holder (AVC series; CoreLab®) capable of applying confining pressures up to 10,000 psi; confining pressure may be applied in the axial and radial directions independently. The flowing pressure on the upstream end of the core holder 1228 during the production cycle is controlled with an Equilibar® U6L Ultra Low Flow Series Precision Back-pressure Regulator (BPR) 1214 (PEEK diaphragm, 0-5000 psig pressure range) with pressure monitored with a pressure transducer 1218 (Model (640-6000-2-35-47-ST8), 0-6,000 psig pressure range, ±0.025% accuracy of full scale). Gas flow rate is monitored at the upstream end of the core holder 1228 using an OMEGA® FMA-1617A-V2 gas flow meter 1216 (0-100 SCCM, ±(0.8% of reading+0.2% of full scale) accuracy, 200:1 turn down ratio). Ultra-High Purity methane (99.97% purity) gas is injected at the upstream end of the core holder 1228 using a gas cylinder 1210; a CPS® Pro-Set® VP2D vacuum pump 1224 (2 stage vacuum pump, ultimate vacuum of 10 micron) is used to evacuate the sample prior to analysis. As would be recognized by the skilled person, these are only examples of components that may be used with the systems and methods described herein, and the disclosure is not to be considered limited to use of these specific components.

The rate-transient core analysis procedure was trialed using a core plug sample 1226 from the Montney Formation. The core plug analyzed has a 1.5 inch (3.8 cm) diameter and 2 inch (5.1 cm) length. The sample 1226 was placed in the instrument core holder 1218 and subjected to a confining pressure of 2000 psi—hydrostatic conditions (pressure equal in radial and axial directions) were applied. A vacuum was applied to the sample 1226 prior to the experiment by opening valve 3 (FIG. 8). Methane gas 1210 was injected at a constant pressure of 1438 psi into the upstream end of the core holder 1228 after valve 1 was opened. After approximately 10 minutes of injection, valve 1 was closed and pressure monitored until equilibrium was reached. In order to speed up the process, valve 2 was held open during the injection and stabilization periods. When equilibrium was reached, valve 2 was closed and valve 1 opened to allow methane gas production from the core 1226. The flowing (production pressure) was controlled with the BPR 1214 at a constant pressure of 1243 psi, using a gas (nitrogen) cylinder regulated at a constant pressure (1243 psi) to control the diaphragm. Pressure was monitored using the pressure transducer 1218 and data was logged every second during gas production cycle. The gas flow rate was monitored at the upstream end using the gas flow meter 1216 and logged with the same frequency as the logged pressure. The recorded pressures and flow rates over time were then used for permeability and pore volume estimation using the RTA procedure described above.

The core plug sample 1226 was obtained from a gas-producing interval of the Triassic Montney Formation of western Canada. The core plug sample (8H) was obtained from a depth of ˜8317 ft (2535 m) and is comprised primarily of siltstone with a ‘bioturbated’ fabric. Bulk x-ray diffraction analysis (XRD) performed on subsamples in close proximity to the core plug (Samples #D and #E in Table 3) suggest a mineralogy dominated by quartz (39-41%), calcite (7-13%), clay (10-16%), dolomite (12-21%), plagioclase (6-11%), and potassium feldspar (6-10%) with minor amounts of pyrite (3-5%). Detrital clay is comprised primarily of illite. The results of Rock-Eval analysis performed on the end-piece of the core plug sample (Table 4) suggest that the sample is organic-lean (0.48 wt %), and hence gas adsorption in organic matter is expected to be low. Previous work on total organic carbon (TOC) content in the Montney determined that the solid fraction is comprised almost entirely of solid bitumen, and judged to be detrimental to reservoir quality (e.g. permeability); however, in the studied sample, the impact of solid bitumen is expected to be negligible due to the very small amount (0.1) of calculated bitumen saturation.

TABLE 3
Summary of XRD data for sub-samples collected in close proximity to the analyzed core
plug.

| Sample | Depth | Quartz | Clay | Calcite | Dolomite | Potassium | Plagioclase | Pyrite |
|---|---|---|---|---|---|---|---|---|
| ID | (ft) | (%) | (%) | (%) | (%) | Feldspar (%) | (%) | (%) |
| #D | 8312.40 | 41 | 16 | 7 | 12 | 10 | 11 | 3 |
| #E | 8325.42 | 39 | 10 | 13 | 21 | 6 | 6 | 5 |

TABLE 4
Summary of the results of Rock-Eval pyrolysis performed on the end-piece of the
analyzed core plug (after trimming).

| | | TOC | | S1 | S2 | HI² | OI³ | | |
|---|---|---|---|---|---|---|---|---|---|
| Sample | Depth | (wt. | Tₘₐₓ | (mg HC/g | (mg HC/g | (mg HC/g | (mg CO₂/g | | Bitumen |
| No. | (ft) | %)¹ | (° C.) | Rock) | Rock) | Rock) | Rock) | PI⁴ | Saturation |
| 8H | 8316.80 | 0.48 | 440 | 0.16 | 0.10 | 21 | 44 | 0.62 | 0.1 |

¹Total Organic Carbon
²Hydrogen Index = (S2 × 100/TOC)
³Oxygen Index = (S3 × 100/TOC)
⁴Oxygen Index = S1/(S1 + S2)

Petrophysical measurements previously performed on the core plug sample are provided in Table 5. The helium porosity estimate, and calipered dimensions of the core served as inputs for the RTA models used to analyze the data below. In-situ water saturation estimates range between 20 and 35%. However, the present-day water saturation of the analyzed core plug is uncertain because: 1) it was drilled more than 10 years ago; and 2) after drilling, it was not stored under well-preserved conditions (unwrapped; room condition) to maintain the “in-situ” water saturation.

TABLE 5
Summary of petrophysical analysis performed on the analyzed core plug.

| | | | | | Pulse-Decay |
|---|---|---|---|---|---|
| | | Grain | Bulk | Helium | Gas (N₂) |
| Sample | Depth | Density¹ | Density² | Porosity | Permeability³ |
| No. | (ft) | (g/cm³) | (g/cm³) | (%) | (md) |
| 8H | 8316.80 | 2.71 | 2.55 | 5.7 | 7.90 × 10⁻⁴ |

¹Obtained using helium pycnometry technique
²Obtained using calipered dimensions of the analyzed core plug
³Slip-corrected pulse-decay gas (N₂) values evaluated at an effective stress of 2277 psi (15.7 MPa)

Two tests were performed on the Montney core plug sample (8H), and the results of one of the tests described in detail below. Only the production cycle of the test is analyzed below—the injection-falloff cycle prior to pressure stabilization could also be analyzed to complement the results of the production cycle.

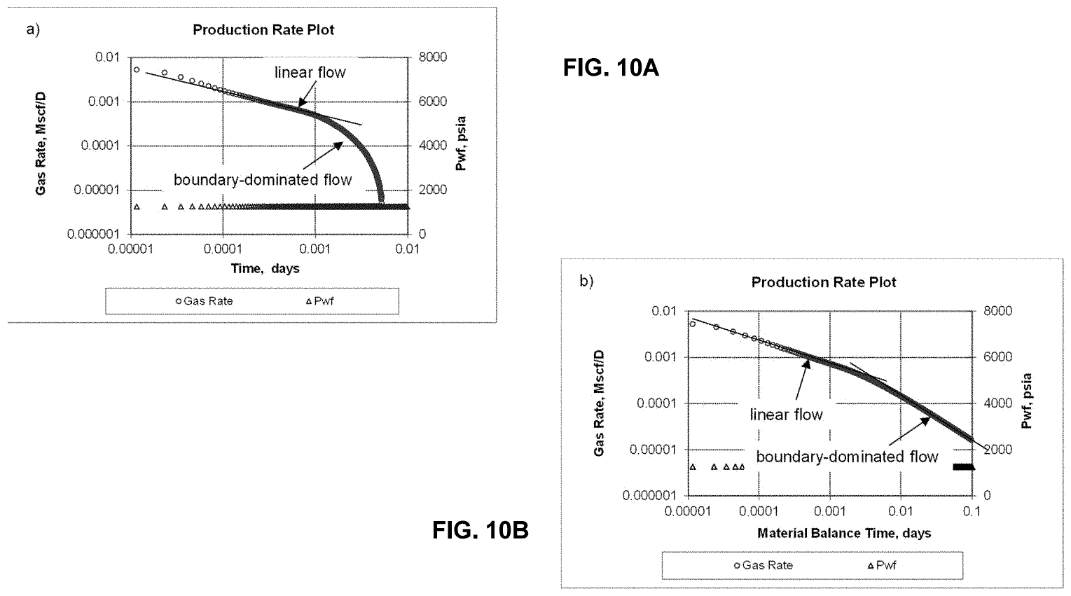

The pressure and rate data associated with the production cycle of the core test is provided in FIG. 9. The pressure in the core stabilized at about 1450 psia after the injection period prior to the initiation of the production cycle. Flowing pressure during the production cycle initiates at ˜1260 psia, and stabilizes at ˜1255 psia for the remainder of the production cycle (nearly constant flowing pressure). The production rate rapidly drops over a period of about 7 minutes to a near-zero rate.

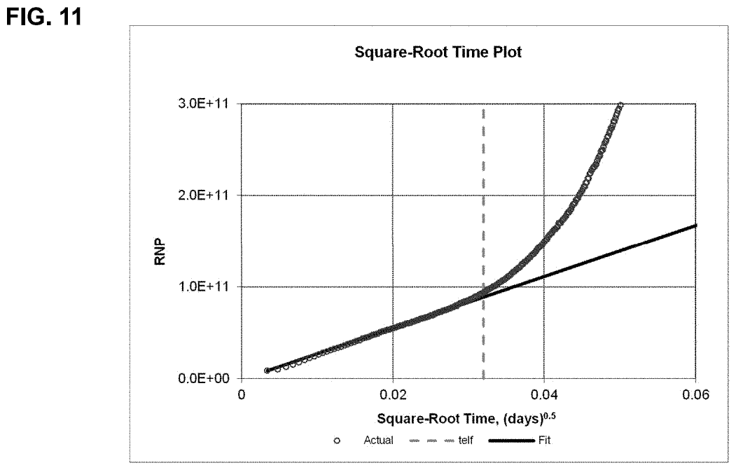

Following a similar analysis procedure as described above, flow-regimes associated with the actual core test are first identified (FIGS. 10A and 10B). For this purpose, log-log plots of gas rate versus time (FIG. 10A) and versus gas material balance time (FIG. 10B) (Eq. 7) are used. In both plots, transient linear flow is identified with the negative ½ slope line; a departure from this line identifies the start of core depletion (boundary-dominated flow). For the plot using material balance time (FIG. 10B), boundary-dominated flow is identified with a unit slope. Consistent with the simulated case, the flow-regime sequence is transient linear flow followed by boundary-dominated flow, and hence the analysis techniques described above are applicable to this actual core test.

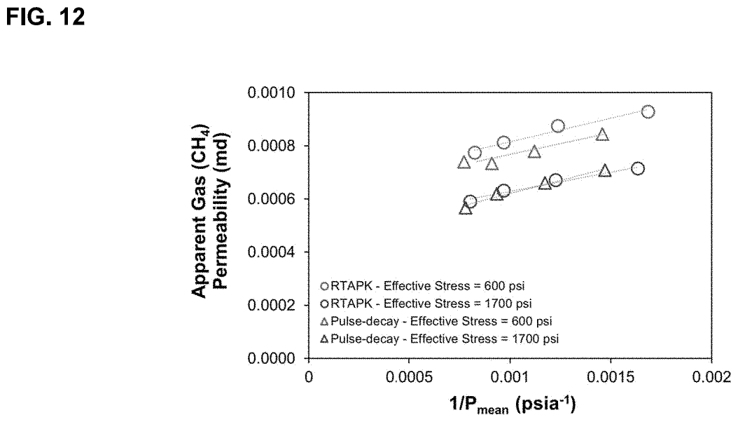

The square-root time plot for the actual core test data is provided in FIG. 11. The end of linear flow is identified with a vertical green dashed line. Applying Eq. 8 (using slope of square-root time plot), a permeability estimate of 6.7×10⁻⁴ md is obtained. Applying Eq. 9 (using end of linear flow time combined with DOI equation), a permeability estimate of 6.9×10⁻⁴ md is obtained. The end of linear flow is only 0.001 days (˜1.5 minutes), meaning that estimates in permeability can be obtained within 2-3 minutes (allowing for some data in boundary-dominated flow regime to be captured for confident identification of end of linear flow).

The pore volume of the core plug can also be obtained using Eq. 10 (from end of linear flow and slope of square-root time plot), and is 1.10×10⁻⁴ ft³; this result compares favorably to an independent estimate (1.12×10⁻⁴ ft³) using the calipered (bulk) volume (1.97×10⁻³ ft³) of the sample multiplied by the porosity (0.057—Table 5).

The results of this (Test 1) core analysis (two independent estimates of methane gas permeability+pore volume) are given along with a repeat run (Test 2, not shown) in Table 6. These results show that the permeability estimates from Eqs. 8 and 9 are consistent (within +/−4%) for each test, and repeatable with acceptable error (within 10%) between tests. Further, the pore volume estimates from the RTA method are within approximately ±2% of the pore volume obtained from calipering the core plug combined with a helium porosity estimate.

TABLE 6
Summary of rate-transient analysis core test results for two independent
tests. The results for Test 1 are reported on in the text.

| | CH₄ | CH₄ | | |
|---|---|---|---|---|
| | Permeability | Permeability | Pore Volume | Pore Volume from |
| Test | from Eq. 8¹ | from Eq. 9¹ | from | Caliper/Pycnometer³ |
| No. | (md) | (md) | Eq. 10² (ft³) | (ft³) |
| 1 | 6.67 × 10⁻⁴ | 6.92 × 10⁻⁴ | 1.10 × 10⁻⁴ | 1.12 × 10⁻⁴ |
| 2 | 7.18 × 10⁻⁴ | 6.89 × 10⁻⁴ | 1.15 × 10⁻⁴ | 1.12 × 10⁻⁴ |

¹These are apparent permeability values to methane gas, and have not been slip-corrected. Measurements are performed at a 2000 psi confining pressure.
²Obtained using Eq. 10 with methane, no correction for adsorption
³Obtained using calipered dimensions of core plug (bulk volume) and grain volume/density from helium pycnometry (Table 5)

The same core plug (8H) analyzed using the new RTA method was re-analyzed using the pulse-decay methodology under similar experimental conditions (and using the same core holder). Methane gas was again used as the analysis gas; the mean pore pressure and confining pressure for the PDP test were 1300 and 1800 psi, respectively, resulting in an effective pressure of 500 psi (similar to the RTA core test). The apparent gas permeability (e.g. without correction for non-Darcy flow effects such as gas slippage) resulting from this test was 8.4×10⁻⁴ md, which is within ±20% of the average of the two RTA tests (Table 6, both permeability estimation techniques). After an initial pressure stabilization within the sample cell (core holder), which is also required for the RTA core test, the time taken to obtain a confident permeability from the PDP test is 30 minutes (after equilibrium of pressure pulse), as compared to ˜2 minutes required to reach the end of linear flow (hence allowing the two permeability estimates) for the RTA procedure. While this time savings for a single data point using the RTA method is significant enough, the real time savings would occur if multiple tests are performed to evaluate stress-dependence of permeability (by adjusting confining pressure in multiple steps) and/or to perform non-Darcy flow corrections (e.g. gas slippage, by adjusting pore pressure in multiple steps). It may be common to perform measurements at an additional 3-4 confining pressures and pore pressures to establish these trends, meaning the cumulative time savings using the RTA method could be very substantial.

An additional comparison can be made with an N₂ pulse-decay test performed on the same sample. The value reported in Table 5 is slip-corrected and performed at a higher effective stress than the CH₄ RTA or PDP test—for the N₂ test performed at a similar effective stress, the Klinkenberg slippage plot was used to estimate apparent N₂ permeability at a pore pressure of 1300 psi (1.4×10⁻³ md), which is significantly higher than that obtained from the CH₄ RTA or PDP test. This difference is expected because of the difference in the molecular (collision) diameters of the gases, and possibly also due to the greater amount of adsorption expected for CH₄ versus N₂, although the latter effect is expected to be relatively small for this low TOC/clay content sample.

Overall, the PDP and RTA test results for this sample, using the same analysis gas at similar experimental conditions, compare favorably.

For the RTA methodology, of the two permeability estimation techniques applied to the production cycle, the one dependent on the identification of the end of transient linear flow (Eq. 9) is expected to be the most error prone. This is because of the potential error in the identification of the end of linear flow, which is more subjective than fitting a line to the slope of the square-root of time plot (Eq. 8). Further, the DOI equation itself may have errors associated with it. For estimation of the end of linear flow time, the derivative (RNP′, Eq. 2) may be used for this purpose. Using the square-root of time plot, a range for the end of linear flow times was obtained by visually assessing the upward deviation from straight-line behavior—this resulted in a range in permeability from 6.92×10⁻⁴ to 8.43×10⁻⁴ md, a difference of just over 20%.

Use of hydrocarbon-based analysis gases (instead of inert gases such as helium) could result in significant adsorption/desorption of gas during the experiments which can affect both permeability and pore volume estimates. Corrections for adsorption-related effects, in particular for organic- and clay-rich samples for which significant gas adsorption is expected, should therefore be made. For the Montney sample analyzed herein, the low TOC and clay content of the sample likely results in negligible gas adsorption. Fortunately, analytical techniques have been developed to account for adsorption/desorption in rate-transient analysis and these corrections have been demonstrated in the analysis of simulated core tests using the RTA method described herein. These corrections do however require independent measurement of an adsorption isotherm using the analysis gas to evaluate the isotherm model inputs used in the RTA corrections.

For non-Darcy flow, it was noted that unsteady-state experiments can be run at multiple pore pressures to establish a relationship between apparent gas permeability and (mean) pore pressure. For PDP tests, a plot of apparent gas permeability versus inverse mean pore pressure (i.e. Klinkenberg slippage plot) is created, and should (theoretically) result in a straight line. This may be interpreted to yield a liquid-equivalent permeability and gas slippage factor. In this case, the cause of the apparent gas permeability change with pore pressure is interpreted to be due to gas slippage effects. However, depending on the combination of pore pressure, temperature, analysis gas, and dominant pore throat size in the sample, other non-Darcy flow effects such as transitional flow and diffusion may be acting to affect the relationship between apparent permeability and pressure. It has therefore been suggested that more general non-Darcy flow models that account for different flow-mechanisms should be used to evaluate the apparent gas permeability versus pressure relationship. The Knudsen number may be used to evaluate which flow mechanism may be operating, and therefore apparent gas permeability may be more directly correlated to Knudsen number, as opposed to pressure.

For the RTA method proposed herein, apparent gas permeability may be obtained from the transient linear flow period, or the end of it. For the case of constant flowing pressure, the pressure in the distance of investigation during transient linear flow period has been demonstrated to be constant and intermediate between the initial pore pressure and the flowing pressure. Therefore, any correlation between apparent gas permeability and pressure should be performed using this average pressure in the DOI. Once a trend is established, a more general non-Darcy flow equation may be used to match the data and to estimate a liquid-equivalent permeability. RTA models may be modified to include an apparent gas permeability value that changes with pressure, and hence any non-Darcy flow model that can be formulated as a function of pressure may be used to correct the data to a liquid-equivalent permeability.

Eqs. 8 and 9 for permeability estimation, and Eq. 10 for pore volume estimation, all assume constant flowing pressure conditions. Although the flowing pressure conditions can be strictly controlled using the back-pressure regulator, there may be cases where the pressure cannot be held constant. In these cases, a more general linear flow analysis plot may be created that uses linear superposition pseudotime that accounts for both pressure-dependent properties and variable flowing pressure conditions.

Analysis of the production cycle for simulated and actual core tests in the current study was performed using straight-line (e.g. square-root of time plot) and distance of investigation methods to calculate permeability and pore volume. Analytical/semi-analytical model history-matches of the rate-time data during the production test can also be used to confirm permeability and pore volume estimation. History-matching could also be performed using a numerical model. Furthermore, dimensionless type-curve methods may also be a useful RTA technique to confirm permeability/pore volume estimation—for the transient linear to boundary-dominated flow sequence, the Wattenberger type-curves are useful for this purpose.

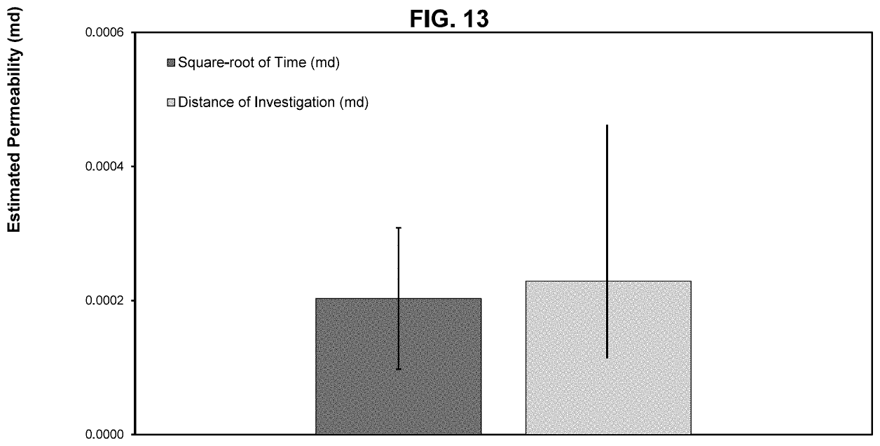

As further verification of the RTAPK technique, the previously-selected core plug sample from the Montney Formation was analyzed using methane (CH₄) at various mean pore pressures (600-1200 psi) and under various effective stress (600-1700 psi) conditions. For comparison purposes, pulse-decay permeability (PDP) measurements were further performed on the same core plug sample under similar experimental conditions (mean pore pressures: 600-1200 psi; effective stress: 600-1700 psi). As can be seen from FIG. 12, apparent CH₄ permeability values—obtained from the DOI equation—decrease consistently (0.00077-0.00061 md) with increasing mean pore pressure (600-1200 psi). Apparent and slip-corrected CH₄ permeability values—obtained from the DOI equation—decrease consistently (0.00060-0.00043 md) with increasing effective stress (600-1700 psi). Apparent and slip-corrected CH₄ permeability values obtained from RTAPK and PDP techniques are consistent within less than ±15%, considering the constant value (0.194) re-derived recently using rigorous analytical models (Behmanesh, H., Clarkson, C. R., Tabatabaie, S. H., and Heidari-Sureshjani, M., 2015, Impact of distance-of-investigation calculations on rate-transient analysis of unconventional gas and light-oil reservoirs: new formulations for linear flow, Journal of Canadian Petroleum Technology, 54 (06), 509-519). The latter observations are important, indicating that 1) upon variation of mean pore pressure and effective stress conditions, the RTAPK-derived permeability values follow the same trends as those expected for PDP-derived permeability values, providing additional credibility to the RTAPK technique, and 2) there is a minimal variation between RTAPK-derived and PDP-derived (routine industry standard) permeability values.

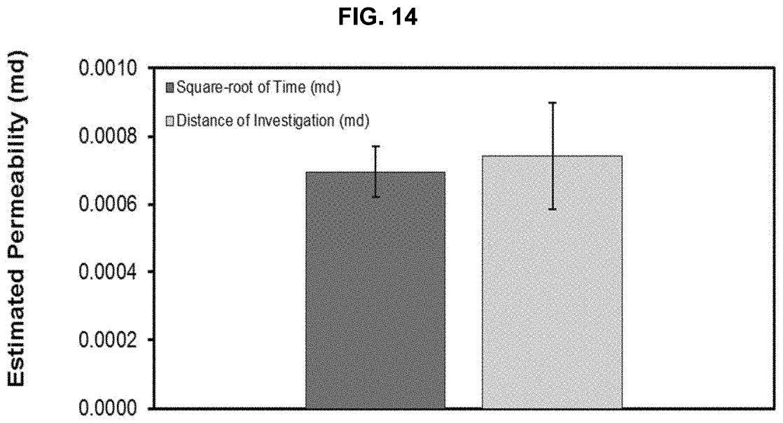

Furthermore, the RTAPK technique may be used for estimating liquid permeability in tight rocks. Conducting a simulation study, oil flow rates were forecasted using Wattenbarger analysis (Wattenbarger, R. A., El-Banbi, A. H., Villegas, M. E. and Maggard, J. B., 1998, Production analysis of linear flow into fractured tight gas wells, Paper SPE 39931 presented at the SPE Rocky Mountain Regional/Low-Permeability Reservoirs Symposium, Denver, Colo., 5-8 April) for two hypothetical low-permeability (0.0002 and 0.0007 md) core plug samples (1.5 inch diameter, 2 inch length, 5.7% porosity) at similar injection (1450 psi) and production (1250 psi) pressures using similar fluid (i.e. oil; 40° API). As can be seen from FIGS. 13 and 14, the latter simulation study indicates that 1) the RTAPK technique is capable of measuring liquid permeability values upon availability of a high-accuracy flow meter and 2) the error associated with the estimated liquid permeability values is expected to increase with decreasing permeability.

With the exploitation of low-permeability (unconventional) reservoirs now possible through the use of advanced drilling and completion technology, there has been an increased demand for laboratory methods to determine key petrophysical properties, such as permeability, to assist with reservoir characterization. There are now several methods available for the assessment of permeability from core plug samples that utilize different physical principals and operate under different experimental conditions. As a result, tests times and results are substantially variable from technique to technique. None of the existing experimental methods can be operated under conditions analogous to that experienced by wells producing from unconventional reservoirs in the field, or reproduce the flow-regime sequence typically experienced by these wells.

### Glossary

### Abbreviations

BPR=Backpressure regulator
DFIT=Diagnostic fracture injection test
DOI=Distance of investigation
EFR=Enhanced fracture region
ELF=End of linear flow
FBUT=Flow/buildup test
LPA=Low-pressure adsorption
MFHW=Multi-fracture horizontal well
PDP=Pulse-decay permeability
PDPK=Pressure-decay profile permeability
PNR=Pseudopressure-normalized rate
PNR′=Pseudopressure-normalized rate derivative
RNP=Rate-normalized pseudopressure
RNP′=Rate-normalized pseudopressure derivative
ROA=Rate-of-adsorption
RTA=Rate-transient analysis
SEM=Scanning electron microscopy
SRV=Stimulated reservoir volume
SS=Steady state
USS=Unsteady state
XRD=X-ray diffraction
XRF=X-ray fluorescence

### Field Variables

A_{c}=core cross-section area, ft²
cₜ=total compressibility, psi⁻¹
cₜᵢ=total compressibility at initial pressure, psi⁻¹
cₜ(p̅)=total compressibility at average pressure, psi⁻¹
f_{cp}=correction factor
k=permeability, md
kₐ=apparent permeability to gas, md
L_{c}=core length, ft
m_{cp}=slope of square-root time plot for constant pressure flowing condition
p_{pg}=real gas pseudopressure, psi²/cp
p_{pg}(pᵢ)=pseudopressure at initial pressure, psi²/cp
p_{pg}(p_{wf})=pseudopressure at flowing pressure, psi²/cp
p=pressure, psi
pᵢ=initial pressure, psi
p_{wf}=flowing pressure, psi
q_{g}=gas flow rate, Mscf/D
Q_{g}=cumulative gas production, Mscf
t=time, days
t_{cg}=gas material balance time, days
t_{cag}=gas material balance pseudotime, days
t_{elf}=time at the end of linear flow, days
T=temperature, ° R
Vₚ=pore volume of core, ft³

### Greek Variables

μ_{g}=gas viscosity, cp
μ_{gi}=gas viscosity at initial pressure, cp
μ_{g}(p̅)=gas viscosity at average pressure, cp
ϕ=porosity, dimensionless, fraction

1. A method for measuring a parameter of a core sample, comprising:
injecting a fluid into a permeable core sample;
allowing the injected fluid to flow out of the core sample by reducing a pressure in an exterior of the core sample relative to an interior of the core sample;
measuring a flow rate of the fluid flowing out of the core sample;
measuring a pressure of the fluid flowing out of the core sample; and
determining, using the measured flow rate and the measured pressure, a parameter of the core sample, wherein the parameter comprises one or more of a permeability and a pore volume of the core sample.

2. The method of claim 1, further comprising, prior to injecting the fluid, evacuating the core sample of gas.

3. The method of claim 1, further comprising, after injecting the fluid and before allowing the fluid to flow out of the core sample, allowing a pressure within the core sample to stabilize.

4. The method of claim 1, wherein the injecting comprises injecting the fluid at multiple entry points in the core sample.

5. The method of claim 1, wherein the core sample is contained in a core holder configured to exert a pressure on the core sample so as to contain under pressure the fluid within the core sample.

6. The method of claim 1, wherein reducing the pressure in the exterior of the core sample comprises using a back-pressure regulator fluidly connected to the core sample.

7. The method of claim 1, wherein determining the parameter comprises using rate transient analysis with the measured flow rate and the measured pressure of the fluid flowing out of the core sample.

8. The method of claim 1, wherein the fluid comprises one or more gases including one or more of methane, argon, nitrogen, carbon dioxide, helium, ethane, and propane.

9. The method of claim 1, wherein, after injecting the fluid, a pressure of the fluid in the core sample is up to about 10,000 psi, or up to about 20,000 psi.

10. The method of claim 1, wherein determining the parameter of the core sample further comprises using: an ambient temperature, a compressibility of the fluid, a viscosity of the fluid, an estimated porosity of the core sample, a cross-sectional area of the core sample, a drawdown correction factor, and a slope of rate-normalized pseudopressure of the fluid flowing out of the core sample as a function of time.

11. The method of claim 1, wherein determining the parameter of the core sample further comprises using: a compressibility of the fluid, a viscosity of the fluid, an estimated porosity of the core sample, a length of the core sample, and a time at which a rate-normalized pseudopressure of the fluid flowing out of the core sample is determined to no longer be linear.

12. A system for measuring a parameter of a core sample, comprising:
a supply of fluid;
a permeable core sample fluidly connected to the supply of fluid;
a core holder configured to apply pressure to the core sample so as to contain under pressure a fluid within the core sample;
a back-pressure regulator fluidly connected to the core sample and configured to reduce a pressure in an exterior of the core sample relative to an interior of the core sample;
a flow sensor for measuring a flow rate of a fluid flowing out of the core sample; and
a pressure sensor for measuring a pressure of a fluid flowing out of the core sample.

13. The system of claim 12, further comprising a vacuum pump configured to evacuate the core sample of gas.

14. The system of claim 12, wherein the core sample is fluidly connected to the supply of fluid via multiple entry points of the core sample.

15. The system of claim 14, wherein the core sample is fluidly connected to the supply of fluid via opposite ends of the core sample.

16. The system of claim 12, wherein the core holder is configured to apply to the core sample a pressure of up to about 10,000 psi, or up to about 20,000 psi.

17. The system of claim 12, further comprising one or more processors communicatively coupled to a computer-readable medium having stored thereon computer program code configured when executed by the one or more processors to cause the one or more processors to perform a method comprising determining, using a flow rate obtained from the flow sensor and a pressure obtained from the pressure sensor, the parameter of the core sample, wherein the parameter comprises one or more of permeability and pore volume.

18. The system of claim 17, wherein determining the parameter comprises using rate transient analysis with a flow rate obtained from the flow sensor and a pressure obtained from the pressure sensor.

19. The system of claim 17, wherein determining the parameter of the core sample further comprises using: an ambient temperature, a compressibility of the fluid, a viscosity of the fluid, an estimated porosity of the core sample, a cross-sectional area of the core sample, a drawdown correction factor, and a slope of rate-normalized pseudopressure of fluid flowing out of the core sample as a function of time.

20. The system of claim 17, wherein determining the parameter of the core sample further comprises using: a compressibility of the fluid, a viscosity of the fluid, an estimated porosity of the core sample, a length of the core sample, and a time at which a rate-normalized pseudopressure of fluid flowing out of the core sample is determined to no longer be linear.
